(19) United States
(12) Patent Application Publication
(10) Pub. No.: US 2024/0079718 A1
(43) Pub. Date: Mar. 7, 2024

(54) BATTERY MODULE COVER ASSEMBLY AND BATTERY MODULE INCLUDING THE SAME

(71) Applicant: HYUNDAI MOBIS CO., LTD., Seoul (KR)

(72) Inventor: Ju Hwan KIM, Yongin-si (KR)

(73) Assignee: HYUNDAI MOBIS CO., LTD., Seoul (KR)

(21) Appl. No.: 18/240,448

(22) Filed: Aug. 31, 2023

(30) Foreign Application Priority Data
Sep. 1, 2022 (KR) 10-2022-0110428

(51) Int. Cl. H01M 50/375; H01M 50/143; H01M 50/383

(52) U.S. Cl. CPC H01M 50/375; H01M 50/143; H01M 50/383

(57) ABSTRACT

The present disclosure relates to a battery module cover assembly and a battery module including the same. A battery module cover assembly according to one embodiment of the present disclosure can include a base plate and a cover which is coupled to the base plate with a heat transfer delay space formed therebetween to delay transfer of heat and in which at least one vent hole for discharging heat is formed.

### CROSS-REFERENCE TO RELATED APPLICATION

This application claims priority to and the benefit of Korean Patent Application No. 2022-0110428, filed on Sep. 1, 2022, the disclosure of which is incorporated herein by reference in its entirety.

### BACKGROUND

### 1. Field of the Invention

The present disclosure relates to a battery module, and more specifically, to a battery module cover assembly with a structure capable of preventing thermal runaway, and a battery module including the same.

### 2. Discussion of Related Art

Unlike primary batteries which cannot be charged, secondary batteries can be charged and discharged, and are used in not only small and high-tech electronic devices such as cell phones, notebook computers, and computers but also power sources for energy storage systems (ESSs), electric vehicles, and hybrid vehicles.

The secondary batteries widely used in the ESSs, the electric vehicles, and the like may be classified into lithium-ion batteries, lithium-polymer batteries, nickel-cadmium batteries, nickel-hydrogen batteries, nickel-zinc batteries, and the like, and are repeatedly charged and discharged with an output voltage of approximately 25 V to 42 V per unit cell. Accordingly, when a higher output voltage and a higher power capacity are required, a plurality of battery cells are connected in series to form battery modules, or the battery modules are connected in series or parallel and are combined with additional other circuits to form battery packs.

However, compared to other batteries, the lithium-ion cells are vulnerable to fire. Typically, thermal runaway occurs when an internal temperature of a lithium-ion battery is 170° C. or more. Accordingly, even when a problem occurs in one battery, a fire quickly spreads to all batteries. To prevent this, there are a method of blocking power using sensors and the like and a method of providing fire extinguishing devices outside a battery, but it is difficult to apply the methods to electric vehicles due to the increases of weight, volume, and cost.

### SUMMARY OF THE INVENTION

The present disclosure is directed to providing a battery module cover assembly for preventing thermal runaway, which has a structure capable of preventing a fire from spreading in each battery module when the fire occurs due to thermal runaway, and a battery module including the same.

According to an aspect of the present disclosure, there is provided a battery module cover assembly coupled to an upper portion of a battery module and including a base plate and a cover which is coupled to the base plate with a heat transfer delay space formed therebetween to delay transfer of heat and in which at least one vent hole for discharging heat is formed.

A heat block sheet which blocks a flame and heat from being transferred to an outside may be disposed on an upper surface of the base plate.

The cover may be provided with at least one support wall for coupling with the base plate in a longitudinal direction.

A positioning protrusion which passes through the heat block sheet and is in contact with the base plate may be provided on a lower end of the support wall.

The base plate may be formed under the cover through molding while being attached to the heat block sheet through the positioning protrusion.

The base plate may be provided with coupling protrusions protruding therefrom and inserted into through holes passing through both sides of the heat block sheet.

The battery module cover assembly may further include a clamp fastened to surround a part of the base plate and a part of the cover.

According to another aspect of the present disclosure, there is provided a battery module including a cell assembly in which a plurality of battery cells are stacked, a cell housing in which the cell assembly is accommodated, and a battery module cover assembly coupled to an upper portion of the cell housing.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a cross-sectional view illustrating a battery module according to one embodiment of the present disclosure;

FIG. 2 is a cross-sectional view illustrating a fire occurring in the battery module according to one embodiment of the present disclosure; and

FIGS. 3 to 6 are views illustrating a process of manufacturing the battery module cover assembly according to one embodiment of the present disclosure.

### DETAILED DESCRIPTION OF EXEMPLARY EMBODIMENTS

Since the present disclosure allows for various changes and numerous embodiments, specific embodiments will be illustrated in the accompanying drawings and described in the detailed description. However, this is not intended to limit the present disclosure to the specific embodiments, and it is to be appreciated that all changes, equivalents, and substitutes falling within the spirit and technical scope of the present disclosure are encompassed in the present disclosure. In the description of the embodiments, certain detailed descriptions of the related art are omitted when it is deemed that they may unnecessarily obscure the gist of the inventive concept.

While terms such as “first” and “second” may be used to describe various components, such components are not limited by the above terms. The above terms are used only to distinguish one component from another.

The terminology used herein is for the purpose of describing particular embodiments only and is not intended to limit the present disclosure. The singular forms are intended to include the plural forms, unless the context clearly indicates otherwise. In the present specification, it should be understood that the terms “comprise,” “comprising,” “include,” and/or “including,” when used herein, specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when something is “connected,” this not only may mean that two or more components are directly connected, but this also may mean that two or more components are indirectly connected through other components or are physically connected as well as electrically connected, or are one thing even referred to as different names according to positions or functions thereof.

Hereinafter, when a battery module cover assembly and a battery module including the same according to the present disclosure will be described in detail with reference to the accompanying drawings, components which are the same or correspond to each other will be denoted by the same reference numerals, and redundant description will be omitted.

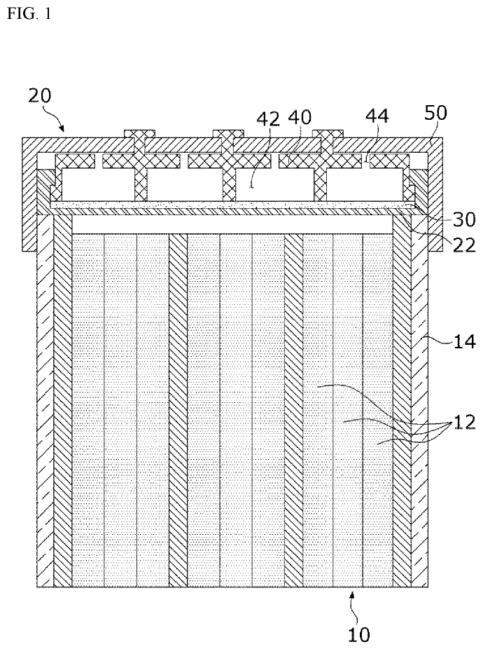

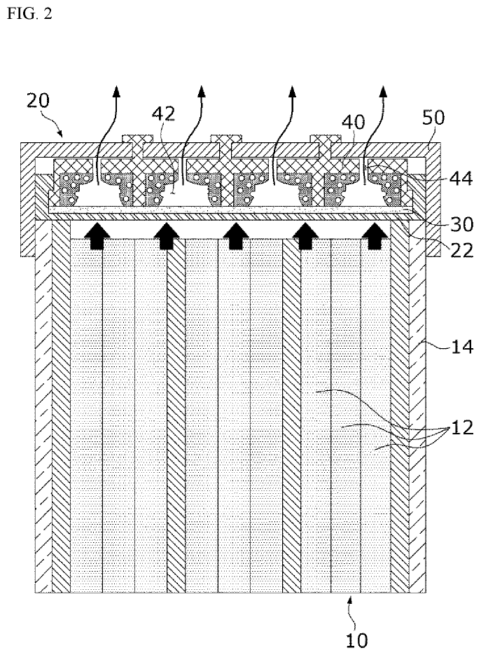

FIG. 1 is a cross-sectional view illustrating a battery module according to one embodiment of the present disclosure, and FIG. 2 is a cross-sectional view illustrating a fire occurring in the battery module according to one embodiment of the present disclosure.

According to the illustrated drawings, a battery module cover assembly according to one embodiment of the present disclosure may include a base plate 22 and a cover 40 which is coupled to the base plate 22 with heat transfer delay spaces 42 formed therebetween to delay heat transfer and in which one or more vent holes 44 through which heat is discharged are formed.

A battery module includes a cell assembly 10 in which a plurality of battery cells 12 are stacked. In the cell assembly 10, the plurality of battery cells 12 may be stacked in a width direction, and in the drawings, it is illustrated that three battery cells 12 are stacked, but the present disclosure is not limited thereto.

A plurality of cell assemblies 10 may be disposed in the width direction, and the cell assemblies 10 may be accommodated in a cell housing 14. The cell housing 14 may be formed in a shape of a plate which surrounds front surfaces, rear surfaces, and side surfaces of the cell assemblies 10, and only the plate which surrounds the side surfaces of the cell assemblies 10 is illustrated in the drawings.

A plurality of battery modules each having the above-described structure may be disposed in parallel to form a battery module assembly. In this case, when a fire occurs in one battery module, since the fire may spread to other battery modules disposed adjacent thereto, the entire battery module assembly may be vulnerable to the fire. In particular, since the cover 40 coupled to an upper portion of the battery module is vulnerable to a flame, there is a problem that the fire spreads through the cover 40. In the present embodiment, the cover 40 has the following structure to prevent the fire from spreading through the cover 40.

A battery module cover assembly 20 includes the base plate 22 coupled to an upper portion of the cell assembly 10. The base plate 22 may be coupled to be spaced a predetermined height upward from the upper portion of the cell assembly 10. Both sides of the base plate 22 may be formed to be bent upward to surround side surfaces of the cover 40.

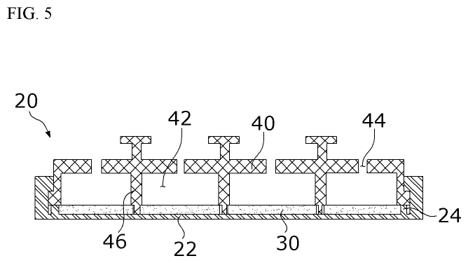

Referring to FIG. 5, coupling protrusions 24 protruding from an upper surface of the base plate 22 are provided at both sides of the upper surface of the base plate 22. The coupling protrusions 24 are inserted into through holes 34 formed in both sides of a heat block sheet 30 which will be described below. When the base plate 22, the heat block sheet 30, and the cover 40 are injection-molded together in a state in which the coupling protrusions 24 are inserted into the through holes 34, the coupling protrusions 24 fill the through holes 34, and thus the coupling protrusions 24 and the through holes 34 are firmly coupled.

Referring to FIGS. 1 and 2 again, the heat block sheet 30 is disposed on the upper surface of the base plate 22. The heat block sheet 30 serves to block a flame and heat from being transferred to the outside when a fire occurs in the battery module. To this end, the heat block sheet 30 may be formed of a flame-resistant and flame-retardant material. The heat block sheet 30 may be attached to be positioned between the both bent end portions of the base plate 22.

Sheet holes 32 into which positioning protrusions 48 of the cover 40 are inserted may be formed in the heat block sheet 30. The sheet holes 32 are each formed at a position corresponding to one of the positioning protrusions 48 and serve to fix mutual positions of the heat block sheet 30 and the cover 40 when the heat block sheet 30 is attached to the cover 40.

As illustrated above, when the heat block sheet 30 is attached to the upper surface of the base plate 22, the flame and heat being transferred to the outside are blocked when the fire occurs in the battery module. In particular, the cover 40 of the battery module is vulnerable to the flame and heat, but since the flame and heat are primarily blocked by the heat block sheet 30, the fire can be prevented from spreading to the adjacent battery modules.

The cover 40 is formed of a synthetic resin material by injection molding and is coupled to the base plate 22 with the heat transfer delay spaces 42 formed therebetween. That is, the cover 40 is coupled to be spaced upward from the upper surface of the base plate 22 with a predetermined space formed therebetween without being coupled in contact with the upper surface of the base plate 22. To this end, both end portions of the cover 40 are formed to be bent downward, and the both bent end portions of the cover are in contact with and coupled to the inside of both sides of the base plate 22.

The cover 40 may be formed in a rectangular plate shape, and the heat transfer delay spaces 42 formed between the cover 40 and the base plate 22 provides spaces in which heat generated by a fire may remain without being discharged to the outside.

Referring to FIG. 2, when thermal runaway occurs in a lithium-ion cell due to an increase in internal temperature, a fire may occur in the battery cell 12, and the fire may spread to the entire cell assembly 10, and a flame and heat may transfer upward. In particular, since the base plate 22 and the cover 40 are formed of materials such as a synthetic resin and a foam-type flame retardant filler, when a fire occurs, liquefiable components in the materials are vaporized and char is formed, and thus air layers and foam layers are generated.

In this case, the air layers and the foam layers allow heat generated due to the fire to remain for a certain time period without allowing the heat to be immediately discharged to the outside. When the cover 40 is coupled in close contact with the base plate 22, the heat may be transferred to the cover 40 and easily transferred to the outside, but since the heat transfer delay spaces 42 are formed, the air layers and the foam layers are formed on inner walls as illustrated in the drawings and the heat can be delayed without being transferred immediately.

In addition, the vent holes 44 are formed in the cover 40 to discharge heat to the outside. The vent holes 44 may be formed on upper portions of the heat transfer delay spaces 42 which are formed between support walls 46.

The support walls 46 are provided on the cover 40 to be coupled to the base plate 22, and one or more support walls 46 may be disposed along the cover 40 in the longitudinal direction. The support walls 46 serve for coupling with the base plate 22 and also serve to stably support the cover 40 on the upper surface of the base plate 22.

The positioning protrusions 48 which pass through the sheet holes 32 of the heat block sheet 30 and are in contact with the base plate 22 are provided on lower ends the support walls 46. The positioning protrusion 48 may protrude from the lower end of the support wall 46 in a boss shape, and a plurality of positioning protrusions 48 may be provided on the lower ends of the support walls 46.

In addition, a clamp 50 may be fastened to surround a part of the base plate 22 and a part of the cover 40. Both end portions of the clamp 50 are formed to be bent downward, and both of the bent end portions are fastened to surround the side surfaces of the base plate 22. The clamp 50 may be fastened to a central portion of the cover in the longitudinal direction without being fastened to the entire cover 40.

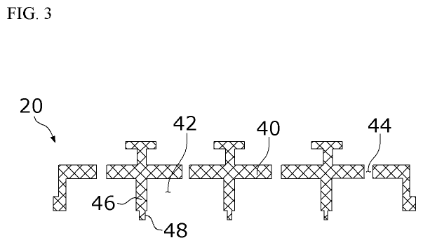

Hereinafter, a manufacturing process of the battery module cover assembly having the above-described structure according to the present disclosure will be described in detail with reference to FIGS. 3 to 6. FIGS. 3 to 6 are views illustrating the process of manufacturing the battery module cover assembly according to one embodiment of the present disclosure.

Referring to FIG. 3, first, the cover 40 is manufactured through a primary injection molding process. The cover 40 may be formed of a material including the synthetic resin and the foam-type flame retardant filler as described above.

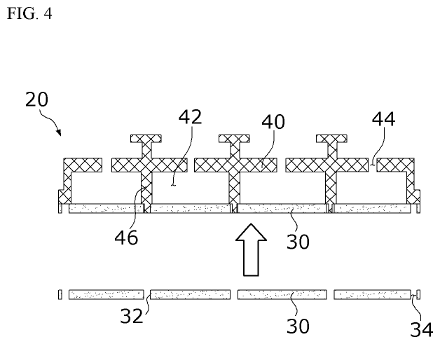

Referring to FIG. 4, the heat block sheet 30 is attached to a lower portion of the manufactured cover 40. Since the sheet holes 32 are formed in the heat block sheet 30 and the positioning protrusions 48 of the cover 40 are inserted into the sheet holes 32, the attachment of the heat block sheet 30 can be easily performed.

Referring to FIG. 5, the base plate 22 is formed under the cover 40 and the heat block sheet 30 through a secondary injection molding process. In this case, as the coupling protrusions 24 of the base plate 22 are injection-molded to be inserted into the through holes 34 formed in the sheet, the coupling can be more firmly performed. In the present embodiment, the reason why the cover 40 is manufactured first through the primary injection molding process and the base plate 22 is manufactured through the secondary injection molding process is that a size of an overall coupling structure is reduced and there is no need to form a separate coupling structure between the cover 40 and the base plate 22.

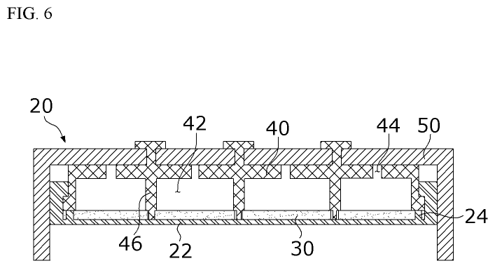

Referring to FIG. 6, the battery module cover assembly 20 is completely manufactured by fastening the clamp 50 to the central portion of the cover 40 in the longitudinal direction. The clamp 50 may be fastened to surround an upper surface of the cover 40 and side surfaces of the base plate 22.

The battery module cover assembly 20 manufactured through the manufacturing process described above is coupled to the upper portion of the cell assembly 10 and an upper portion of the cell housing 14 to form the battery module as illustrated in FIG. 1.

According to one embodiment of the present disclosure, since a fire can be prevented from spreading in each battery module when the fire occurs due to thermal runaway, damage to a vehicle can be minimized, and the safety of a passenger can be secured.

While the present disclosure has been described above with reference to exemplary embodiments, it may be understood by those skilled in the art that various modifications and changes of the present disclosure may be formed within a range not departing from the spirit and scope of the present disclosure defined by the appended claims.

What is claimed is:

1. A battery module cover assembly coupled to an upper portion of a battery module, comprising:
a base plate; and
a cover which is coupled to the base plate with a heat transfer delay space disposed between the base plate and the cover to delay transfer of heat, the cover including at least one vent hole for discharging heat.

2. The battery module cover assembly of claim 1, further comprising a heat block sheet disposed on an upper surface of the base plate to block a flame and heat from being transferred to an outside.

3. The battery module cover assembly of claim 2, wherein the cover includes at least one support wall for coupling with the base plate in a longitudinal direction.

4. The battery module cover assembly of claim 3, further comprising a positioning protrusion disposed on a lower end of the support wall and passing through the heat block sheet to be in contact with the base plate.

5. The battery module cover assembly of claim 4, wherein the base plate is disposed under the cover through molding while being attached to the heat block sheet through the positioning protrusion.

6. The battery module cover assembly of claim 2, wherein the base plate includes coupling protrusions protruding therefrom and disposed in holes passing through both sides of the heat block sheet.

7. The battery module cover assembly of claim 1, further comprising a clamp fastened to surround a part of the base plate and a part of the cover.

8. A battery module comprising:
a cell assembly in which a plurality of battery cells are stacked;
a cell housing in which the cell assembly is accommodated; and
the battery module cover assembly according to claim 1 coupled to an upper portion of the cell housing.

9. A battery module comprising:
a cell assembly in which a plurality of battery cells are stacked;
a cell housing in which the cell assembly is accommodated; and
the battery module cover assembly according to claim 2 coupled to an upper portion of the cell housing.

10. A battery module comprising:
a cell assembly in which a plurality of battery cells are stacked;
a cell housing in which the cell assembly is accommodated; and
the battery module cover assembly according to claim 3 coupled to an upper portion of the cell housing.

11. A battery module comprising:
a cell assembly in which a plurality of battery cells are stacked;
a cell housing in which the cell assembly is accommodated; and
the battery module cover assembly according to claim 4 coupled to an upper portion of the cell housing.

12. A battery module comprising:
a cell assembly in which a plurality of battery cells are stacked;
a cell housing in which the cell assembly is accommodated; and
the battery module cover assembly according to claim 5 coupled to an upper portion of the cell housing.

13. A battery module comprising:
a cell assembly in which a plurality of battery cells are stacked;
a cell housing in which the cell assembly is accommodated; and
the battery module cover assembly according to claim 6 coupled to an upper portion of the cell housing.

14. A battery module comprising:
a cell assembly in which a plurality of battery cells are stacked;
a cell housing in which the cell assembly is accommodated; and
the battery module cover assembly according to claim 7 coupled to an upper portion of the cell housing.
